(19) United States
(12) Patent Application Publication
(10) Pub. No.: US 2026/0220481 A1
(43) Pub. Date: Jul. 30, 2026

(54) Learning to Rank via Univariate Ordinal Regression

(71) Applicant: Google LLC, Mountain View, CA (US)

(72) Inventor: Gil Shamir, Sewickley, PA (US)

(21) Appl. No.: 19/144,829

(22) PCT Filed: Dec. 30, 2022
(86) PCT No.: PCT/US2022/054359

§ 371 Date: Jun. 30, 2025

(51) Int. Cl. G06N 3/096

(52) U.S. Cl. CPC G06N 3/096

(57) ABSTRACT

A relaxed solution of ordinal regression, which constrains the solution to a grid of thresholds learned over training example data is disclosed. A single shift parameter is predicted for each example, shifting that grid to produce a distribution of label predictions. Ranking losses for both pairwise on pairs of examples, and listwise on lists of several examples are disclosed. The use of distillation for both pointwise and ranking losses are described. Use of relaxed ordinal regression with a pre-set grid of thresholds are described, and. an additional temperature parameter is introduced to the different losses and settings as a. method that allows for more flexibility on the solution's modality, which can help in providing unimodality when possible or necessary, but allowing for multimodality when necessary.

### FIELD

The present disclosure relates generally to machine learning. More particularly, the present disclosure relates to learning to rank via univariate ordinal regression.

### BACKGROUND

Ordinal regression is used for various types of multi-label classification problems. Such species include classification problems where the labels describe ordering of outcomes in applications and, when making label predictions, the preservation and leverage of the label ordering is important. Various techniques relax solving ordinal regression to fit a more simplified and constrained model. One specific such model is that of logistic, or some other distribution, where some ordering grid of thresholds is assumed to be common to the whole dataset (or to some slice of the dataset), and each example presents a different shift of this grid of thresholds in the logit domain. The shifted ordered logits are then transformed into generating a cumulative distribution function (CDF) of predicted labels per example. Training learns the grid for the whole dataset (or dataset slice), as well as a model that produces the shift value for each input example. Conventional techniques that optimize a pointwise per-example loss have been developed. Such conventional techniques implicitly assume independence between different examples, including those that may appear together in an example set shown to a user in. Such conventional techniques may be employed in a recommendation system.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method to perform learning of a ranking model. The ranking model (or prediction model) may include a set of parameters and a link function that includes a set of weights. A set of training data for learning the ranking model includes, for each item of a set of items, a ground-truth label, of a set of labels that includes an ordering, for the item and an encoding of the item in a first domain. The method includes, for each item of the set of items, processing, by a computing device, the encoding of the item with the link function to generate an item score scalar for the item. The item score corresponds to a second domain that is associated with a univariate distribution of the set of labels for the item. Each parameter of the set of parameters corresponds to a threshold point for a separate label of the set of labels in the second domain. The set of parameters characterizes the univariate distribution of the set of labels for the item. The link function maps the first domain to the second domain. For each item of the set of items, the computing device may determine an item score vector for the item. Each component of the item score vector for the item corresponds to a corresponding label of the set of labels and is based on evaluating the link function at an argument associated with a difference between the item score scalar for the item and the threshold point for the corresponding label. The link function may be a monotonically increasing function with respect to the item score scalar for the item. The computing device may evaluate a ranking loss function based on a comparison between the ground-truth label and the item score vector for each item of the set of items. The computing function may train the ranking model based on the ranking loss function. The trained ranking model ranks the set of items based on the univariate distribution of the set of labels for each item of the set of items.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs ranking via univariate ordinal regression according to example embodiments of the present disclosure.

FIG. 1B depicts a block diagram of an example computing device that performs ranking via univariate ordinal regression according to example embodiments of the present disclosure.

FIG. 1C depicts a block diagram of an example computing device that performs ranking via univariate ordinal regression according to example embodiments of the present disclosure

FIG. 2A. shows a mapping from a domain native to encodings of items included (or encoded) in a training data set to a second domain of a univariate probability distribution via a learned link function, according to various embodiments;

FIG. 2B shows a determination of the item score vectors from the item score scalars via a link function, according to various embodiments;

FIG. 3 shows a shift in the CDF for each of the items in the set of training data according to various embodiments;

FIG. 4-11 show various experimental results generated by the various embodiments; and

FIG. 12 depicts a flowchart diagram of an example method for training a ranking model, according to example embodiments of the present disclosure.

Reference numerals that are repeated across plural figures are intended to identify the same features in various implementations.

### DETAILED DESCRIPTION

### Overview

The embodiments are directed towards methods and systems that learn to rank elements of a set of elements via ordinal regression (e.g., learned ordinal regression models). As described further below, the ordinal regression models of the embodiments are relaxed or constrained models when compared to techniques that allow for learning a probability mass function (PMF) without constraints. The method considered relaxes the problem of learning multiple parameters to describe a PMF for every example to a problem of learning a single parameter per example that together with a link function and a set of shared thresholds learned across the full dataset or slices of the full dataset describe a PMF over the predicted labels. A link function is employed to link a multiple-dimensional domain of an encoding of an item to a single dimension domain of a single parameter describing a multi-label probability distribution. The learned ordinal regression models of the embodiments may be optimized for better ranking of examples based on the observed labels of training examples. A model which was optimized for better ranking may include a set of parameters which together with a link function can be used to predict probabilities of different labels. The embodiments include training methods to learn the set of parameters of the ranking model based on a set of training data (or training examples). Each data point (or example) of the training data may be labeled with one or more ground-truth labels.

More specifically, the embodiments determine pairwise and/or listwise ranking losses for a relaxed ordinal regression use for training a model and specifically emphasizing on improving ranking among items with different labels in a list. Such losses enhance the ranking relations between different items that may be co-recommended together in a recommendation system (or other systems) instead of focusing on the individual (marginalized) predictions. Doing so can improve predictions based on interactions between different items co-recommended together. Such interactions may be de-emphasized by a conventional marginalized individual loss. The approaches of the embodiments may be combined with the individual engagement pointwise loss to emphasize better ranking among different items. The approaches may also be applied in a distillation set ups. Some embodiments may include the use of loss temperatures with fixed threshold grids that give better control over the modality of the solution, as well as indicate their ranking and distillation loss variants.

Some multi-class multi-label systems are trained to predict Probability Mass Functions (PMFs) of the label probabilities for each of the possible outcomes. Softmax predictions with logistic loss can be used to train such models, where there is no ordering among the predicted labels. In many applications, however, there can be a clearly defined ordering among the class labels. Such ordering can be included in the training objective, so that predictions are adjusted to utilize the ordering relations. For example, human ratings of objects can classify objects to language-based or numerical classes, where there can be a clear order in applications where human labelers (or users) may rate the relevance of an item to some desired goal.

Ordinal regression may provide support to learning multiple classes with multiple labels where a defined ordering is preserved. Specifically, instead of learning the individual class probabilities, a Cumulative Distribution Function (CDF) can be learned for each of the labels. One method to learn the CDF applies binary regression for each of the classes on the event that the true label is not greater than some value. If there are L labels, this allows learning L−1 parameters, which are points on a staircase CDF. By itself, this approach may not significantly differ in the predictions it produces from performing multi-label classification with a softmax loss (it just uses a different basis in the signal space). The predicted CDF points can be transformed by taking their differences into the PMF of the different classes. However, because the predicted CDF retains the order of the classes, various methods can be applied on top of this method to smooth labels, smearing categories into each other, giving the ability to smooth subjective labels (such as human generated labels). This approach may support an additional pairwise or listwise ranking loss that can emphasize on differences between labels of two or more items co-recommended to the user for the same query. Various methods enable the production of a general PMF over the predicted labels, which is corrected to emphasize ranking differences between co-recommended items.

While these approaches described above may be suited for various forms of true PMF of the L (ordered) class labels, in many applications the PMF may be defined by a set of parameters which is smaller than the L−1 parameters needed to describe any PMF over L classes. Specifically, the CDF may be expected to take some general form, which for any example can be shifted in some domain by an amount determined by a single shift parameter. In the embodiments, the form of ordinal regression may be adapted. For the adapted form, it may be assumed that there is some domain (e.g., a 1D domain) in which the CDF of labels for all examples is a linear shift of a grid of points in that domain. This domain may be associated with the CDF. The shift may differ among the different examples, but the spacing in the grid is common to all examples. Each of the L−1 CDF points (excluding 0 on the left and/for the Lth label on the right) is on a grid of points in that domain. For each example, that grid is shifted by a shift (or delta) that is a function of the example. The domain can be a probit domain, where the transformation of the grid point to probability is done by computing a standard normal CDF at that point. It can be a logit domain, where the standard logistic CDF transforms the point on the grid to a probability, or it can be any other domain. With such a model, ordinal regression can learn a unified set of L−1 thresholds for the base points of the CDF in the original domain, with an additional parameter per-example, that learns the shift of the thresholds for the specific example. A generalized linear model, a deep network, or any other model can be used to learn the per example shift, together with learning the marginalized thresholds over all examples. These thresholds can also be learned for families of examples instead of the whole dataset together, if one does not expect a single model to fit all examples. For example, for human labeled data, the thresholds can be learned for each labeler. If the same model clusters different recommendation properties, different thresholds can be learned for each property.

Unlike unconstrained ordinal regression model, the models of the embodiments employ the constrained method which learns ordinal regression with an almost univariate solution (or as a relaxed ordinal regression). In many recommendation problems, one is interested in better ranking of co-recommended items, not only in accurate individual predictions of item engagement rates. Unfortunately, optimizing for the latter does not always give the best ranking performance. This is because optimizing for individual rates may marginalize the interaction effects on engagement of multiple co-recommended items. Furthermore, due to model misspecification, optimizing marginalized rates may lead to different models from optimizing for item interactions. One loss optimizes the marginal. It may be shown that the other optimizes a conditional probability, where, in fact, what a model really needs to capture is the joint probability of multiple items. However, in large scale recommendation systems, this may be infeasible due to the huge interaction set of multiple items.

Some embodiments of the proposed method apply a ranking specific loss that focuses on interactions between items when optimizing a link function constrained version of ordinal regression. The ranking loss may emphasize the interaction between different items, as opposed to the individual label predictions for the different items. Various embodiments may apply variations of threshold grids. These variations may affect the modality of the solution. Still additional embodiments may add a learned temperature parameter to the link function, which gives more flexibility to a constrained ordinal regression solution.

### Example Devices and Systems

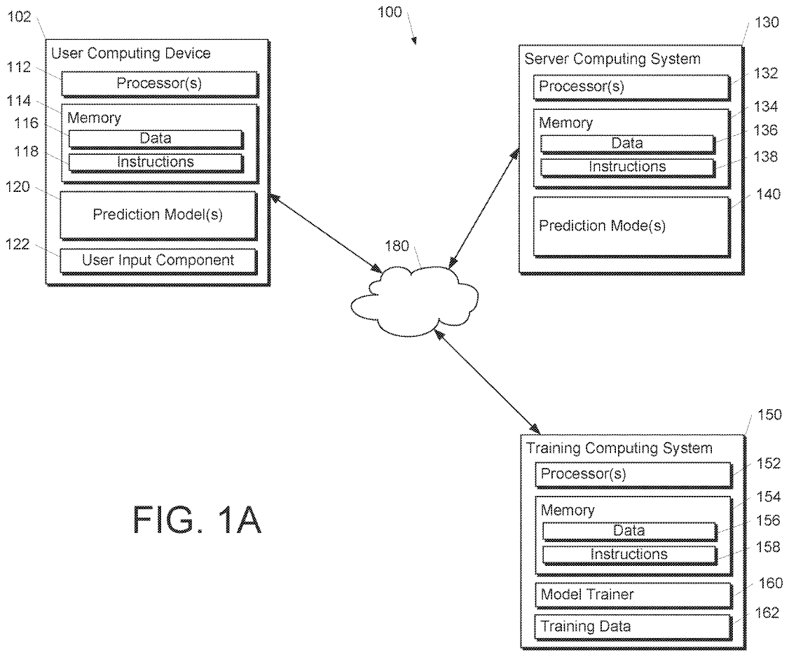

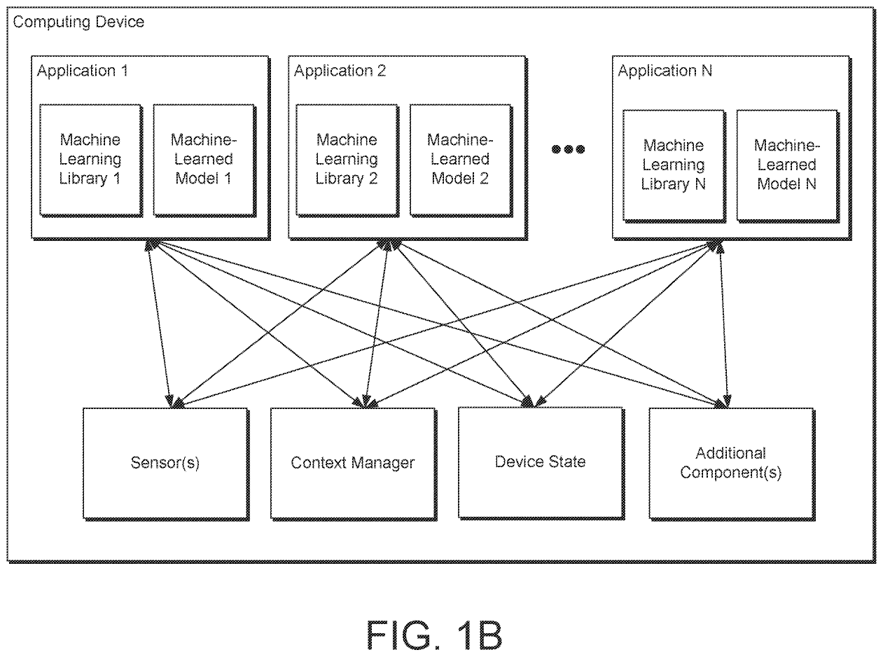

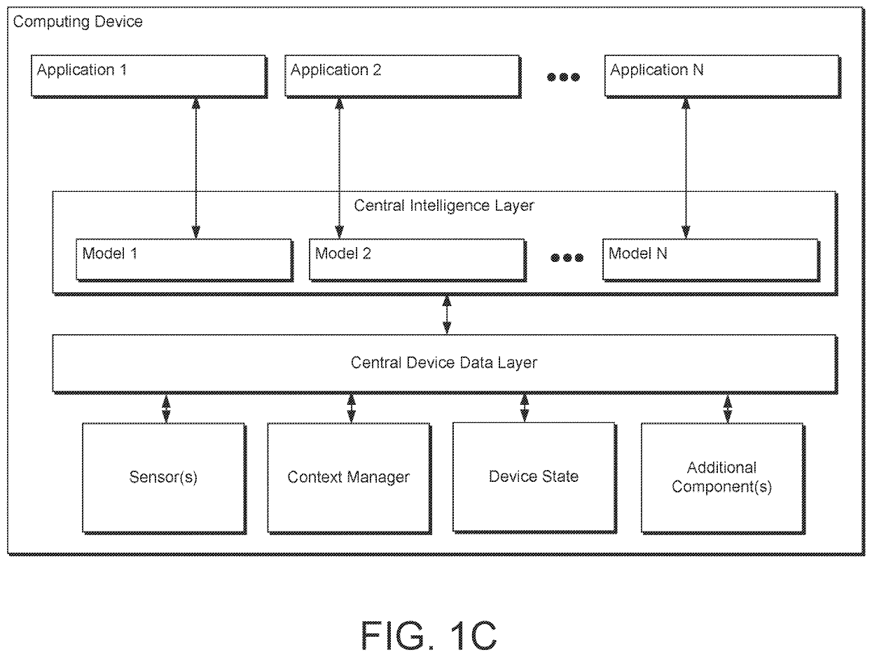

FIG. 1A depicts a block diagram of an example computing system 100 that performs ranking via univariate ordinal regression according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

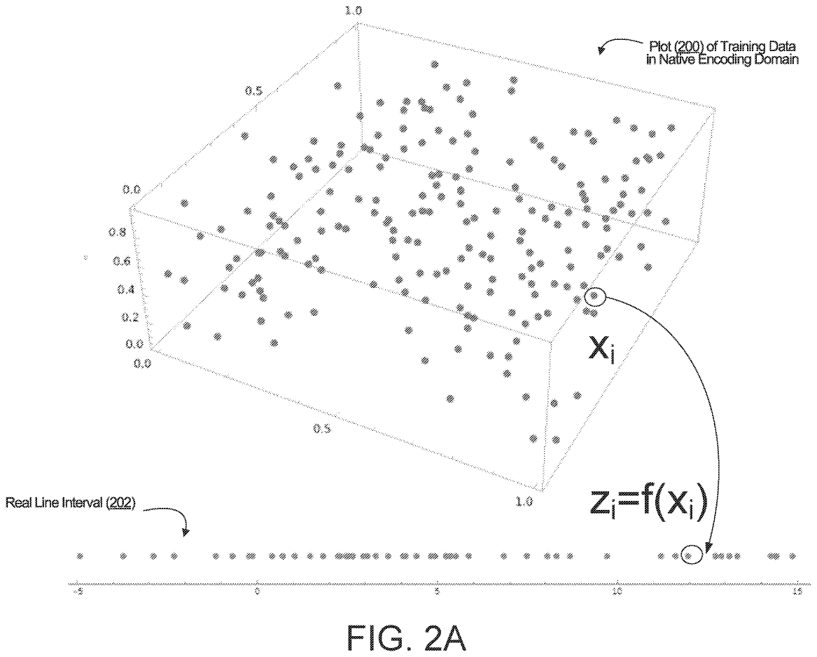

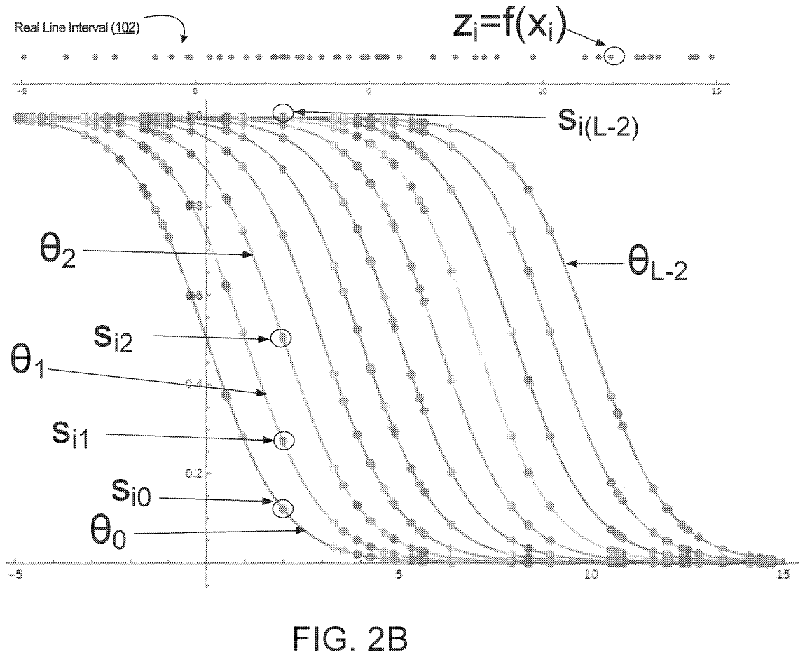

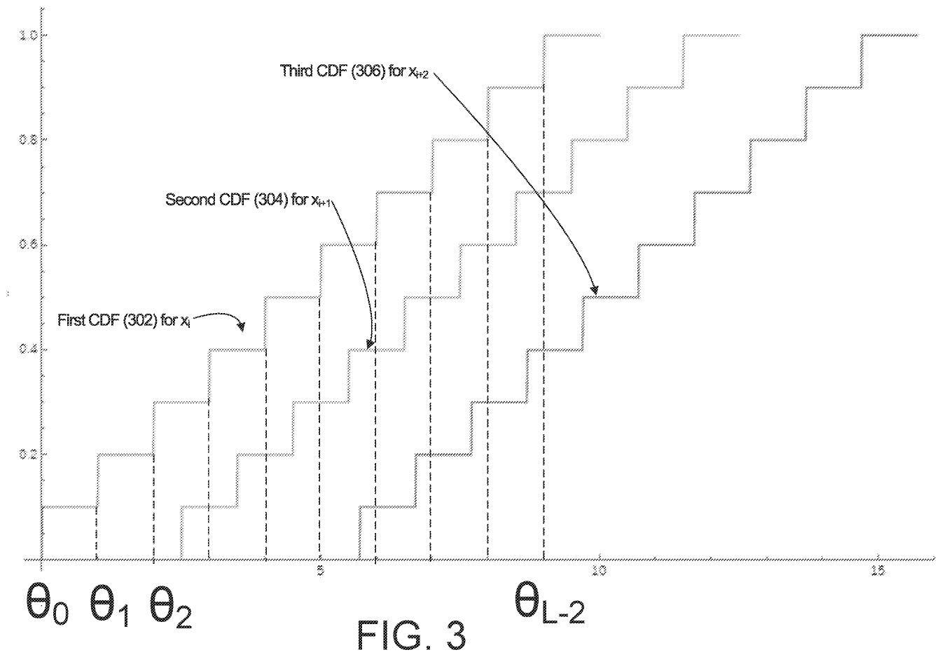

In some implementations, the user computing device 102 can store or include one or more prediction models 120. For example, the prediction models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example prediction models 120 are discussed with reference to at least FIGS. 2A-3.

In some implementations, the one or more prediction models 120 can be received from the server computing system 130 over network 180, stored in the user computing device memory 114, and then used or otherwise implemented by the one or more processors 112. In some implementations, the user computing device 102 can implement multiple parallel instances of a single prediction model 120 (e.g., to perform parallel ranking via univariate ordinal regression across multiple instances prediction models 120/130).

Additionally or alternatively, one or more prediction models 140 can be included in or otherwise stored and implemented by the server computing system 130 that communicates with the user computing device 102 according to a client-server relationship. For example, the prediction models 140 can be implemented by the server computing system 140 as a portion of a web service (e.g., a ranking via univariate ordinal regression service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more prediction models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example prediction models 140 are discussed with reference to FIGS. 2A-3.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the prediction models 120 and/or 140 based on a set of training data 162.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50. The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Relaxed (or Univariate) Ordinal Regression

FIG. 2A. shows a mapping from a domain native to encodings of items included (or encoded) in a training data set to a second domain of a univariate probability distribution via a learned link function, according to various embodiments. This section considers a system that learns on multiple queries. For the t^{th} query, there are N examples which are co-recommended in the training set. Because some embodiments focus on the loss per query or per example, it may be convenient to omit the dependence on t, where it is understood that any loss defined is summed over all the t queries. Plot 200 of FIG. 2A shows N examples in a training data set. The training data included items (or examples) encoded in vector embedding in a first (or native encoding) vector space. The vector encoding of the ith training data point (e.g., the ith example or the ith item) may be referenced as the vector xᵢ. Thus, the vector embeddings (e.g., xᵢ) may be of the same dimension as the first vector space. The first vector space may be referred to as a first domain and/or a native domain. Due to limitations of the 2D representation of a page, the first domain is shown as a 2D projection of a 3D vector space. However, the embodiments are not so limited, and the first domain (or vector space) can include significantly more dimensions than three.

Each example data point of the training data is labeled with one or more ground-truth labels yᵢ∈{0, 1, 2, 3, . . . , L−1}. For purposes of clarity, the ground-truth labels associated with the vector embeddings are not shown in FIG. 2A. Note that the set of labels {0, 1, 2, 3, . . . , L−1} may be an ordered (and enumerated) set of labels. Without loss of generality, each example (or training) data point i:i∈{1,2,3, . . . , N} of the training data can take one of the ordered L label values yᵢ∈{0, 1, 2, 3, . . . , L−1} as the associated ground-truth label. That is, each data point of the training data may be labeled with at least one ground-truth label: yᵢ. Each data point in the training data may be referred to as an item because the data point encodes a set of items. Thus, each data point of the set of training data may include an item of a set of items, an encoding (e.g., a vector encoding or embedding in the first or native domain) of the item, and a ground-truth-label for the item.

The labels (of the set of labels) may be ordered and thus enumerated starting at 0 because in many applications 0 can have a special meaning. For example, the label corresponding to yᵢ=0 may be associated with no engagement, and other labels describe some level of engagement. Labels can be verbal labels, but with ordering, such as {‘irrelevant’, ‘low relevance’, ‘medium relevance’, ‘highly relevant’}.

As discussed below, a link function is employed to transform a scalar value (e.g., an item scalar score discussed below) for each example training data point into a probability value normalized between [0,1]. A link function may transforms from the real domain to a probability. In some embodiments, a constrained version of ordinal regression uses either a logistic or normal CDF link function. This is emergent from the view of the method as learning a random variable contaminated by noise that takes this distribution, where measurements provides a range for the value of the variable instead of an exact measurement. The following discussion focuses on the link function being a logistic function, but it should be understood that the same approach can be applied in a different domain, where the parameters are transformed by some link function to a CDF. That is, other embodiments may include a link function that is not a logistic function. Let θ₀≤θ₁≤ . . . θ_{L-2} be a grid of thresholds in the logit domain. The set of {θ₀≤θ₁≤ . . . θ_{L-2}} may be referred to as the set of threshold parameters. The values for the set of the threshold parameters may be learned according to the various embodiments. The thetas may be thresholds to determine label range boundaries for the ordinal regression. Let the ranking model produce a score zᵢ=ƒ(xᵢ) for example xᵢ, where ƒ(xᵢ) is zᵢ a prediction according to some defined model for examples x_i. The value zᵢ=ƒ(xᵢ) may be referred to as an item score scalar for the ith item in the training data. As shown in FIG. 1, the prediction model maps the first domain (e.g., the vector space of plot 200) to a real line interval 102. The mapping is shown explicitly for the data point in the plot 102 marked as xᵢ and the corresponding point of the real line interval marked as zᵢ=ƒ(xᵢ) The prediction model may include a set of weights that are also learned via the embodiments. The prediction model may generate a function ƒ(xᵢ) to produce a score for label yᵢ. The score together with the set of thresholds and a link function will produce a prediction of the label. In at least one embodiment, the cardinality of the set of weights of the prediction models equivalent to the dimensionality of the first vector space of the vector embeddings. In such embodiments, the set of weights of the model maybe encoded in a weight vector: w. In such embodiments, the prediction model may take the form of ƒ(xᵢ)=w. xᵢ, e.g., the standard inner product of the feature embeddings and the weights.

The model prediction score z_i=f(x_i) and the thresholds theta are used to compute item label score vectors sᵢₗ, where the subscript i refers to the ith item of the training data and the subscript [symbol] refers to the component of the item score vector. Each component of the item score vector corresponds to a separate label of the set of labels, as referenced by the index [symbol] . Each component of the item score vector for an item may be referred to as a logit score for the corresponding label. The logit score (or component of the item score vector for the ith item) for the ith example at the CDF point for corresponding label [symbol] may be given by

$${s}_{i ℓ} \hat{=} {θ}_{ℓ} - f ( {x}_{i} ) . \qquad ( 1 )$$

Each component (or logit score) of the item score vector for the item can be transformed (or mapped) into a univariate probability distribution (e.g., the CDF) point via the Sigmoid function: σ(θₗ−ƒ(xᵢ)). By definition of the CDF point this probability is the probability that item i takes a label equal to [symbol] for smaller. In various non-limiting embodiments, this probability is given by the logistic (e.g., a sigmoid)

$$Pr ( {y}_{i} \leq ℓ \vert {x}_{i} ) = σ ( {θ}_{ℓ} - f ( {x}_{i} ) ) = \frac{1}{1 + \text{?}} . \qquad ( 2 )$$

$$\text{?} \text{indicates text missing or illegible when filed}$$

FIG. 2B shows a determination of the item logit scores from the threshold vectors and the example predicted score z_i, according to various embodiments. In the non-limiting embodiment of FIG. 2, the link function takes the form of the logistic function of equation 2. Each continuous curve is a plot of the link function for a separate parameter of the set of threshold parameters, e.g., a separate θₗ. Note that in the non-limiting embodiment of FIG. 2B, the shift between consecutive threshold parameters (e.g., the shift along on x-axis among consecutive curves) appears uniform. Note that the embodiments are not so limited, and the “learned” shifts between consecutive threshold parameters may be non-uniform and may vary from threshold to threshold. Each of the item scores shown on the real line interval 102 is mapped to each of the continuous curves, based on the link function and the corresponding parameter. Some of the components (e.g., the [symbol] =0, 1, 2, and L−2 components) of the item logit scores for the ith item are shown in the circles and indicated as such (e.g., sᵢ₀, sᵢ₁, sᵢ₂, s_{i(L-2)}). Note that selecting the logit via equation (1) as a link function to describe the CDF (i.e., the probability that yᵢ takes a label no greater than l) gives a monotonically increasing relation between the probability of the largest label and ƒ(xᵢ). Thus intuitively increasing ƒ(xᵢ) implies a greater probability for aggregations of larger label values which include all labels above some [symbol] . This makes the solution of ordinal regression in a way consistent with solutions of linear, logistic and other regressions, in the sense that increasing the score for the example generally implies a better label. Intuitively, for other regressions this means that the score shifts right on some x-axis giving larger predictions. For ordinal regression, it means that for a fixed link function describing a Probability Density Function (PDF), the threshold grid shifts left relative to the link function giving a larger area of the PDF to be covered by the accumulation of larger value labels.

FIG. 3 shows a shift in the CDF for each of the items in the set of training data, where the shift is generated by the prediction score, according to various embodiments. FIG. 3 illustrates a first CDF 302, which may correspond to the ith item, a second CDF 304, which may correspond to the (i+1)th item, and a third CDF 306, which may correspond to the (i+2)th item. (ᵢ) Converting the staircase CDF into PMF, the probability the model assigns to label yᵢ taking value [symbol] is then given by

$$Pr ( {y}_{i} = ℓ \vert {x}_{i} ) = \frac{1}{1 + \text{?}} - \frac{1}{1 + \text{?}} \qquad ( 3 )$$

$$where {θ}_{- 1} = - ∞ and {θ}_{L - 1} = ∞ .$$

$$\text{?} \text{indicates text missing or illegible when filed}$$

Observing yᵢ, a logistic regression model can be used to minimize logarithmic loss (or in turn to produce the maximum likelihood values over the dataset). The loss for example i is thus given by

$$( 4 )$$

$$\text{?} = - {\sum }_{ℓ = 0}^{L - 1} I ( \text{?} = ℓ ) log Pr ( \text{?} = ℓ \vert {x}_{i} ) = - {\sum }_{ℓ = 0}^{L - 1} I ( \text{?} = ℓ ) log [ \frac{1}{1 + \text{?}} - \frac{1}{1 + \text{?}} ]$$

$$\text{?} \text{indicates text missing or illegible when filed}$$

where I(.) is the indicator function. Thus the summand is not zero only for [symbol] =y_i. The loss is then used to optimize θₗ, θₗ₋₁, and ƒ(xᵢ) by, for example, applying SGD with gradients of equation (4) relative to these parameters. ƒ(xᵢ) can be a dot product of learned weights for the components of xᵢ in a linear model, an output of a neural network with feature inputs xᵢ, or an output of any other type of model which generates some score from the input feature vector xᵢ. We recall that ƒ(xᵢ) is learned for each example xᵢ, whereas the thresholds θₗ, θₗ₋₁ are updated with example xᵢ, but also with any other example, where their overall solution is marginalized over the whole dataset, or over some slice of the dataset that contains multiple examples. Note that similarly to FIG. 2B, the learned shifts between consecutive threshold parameters (e.g., the shift along the x-axis between consecutive “staircase) curves) appears uniform. As noted in the discussion in conjunction with FIG. 2B, the embodiments are not so constrained, and non-uniform shifts in threshold parameters may be learned via the data in the various embodiments. Also note that in the non-limiting example of FIG. 3, each CDF appears to be uniform in that the distance along the x-axis between consecutive steps appears uniform, along with the “vertical size” of the step (e.g., the “jump” along the y-axis) for each step appears uniform. Note that the embodiments may learn CDFs that include “step sizes) along both the x-axis and γ-axis that are not uniform, as implied in FIG. 3.

### Ranking for Relaxed Ordinal Regression—Pairwise Losses

A pairwise ranking loss can be defined through a conditional probability of item A being better than B conditioned on the event that one item is better than the other. Using this conditional probability, minimizing the pairwise loss over a sequence of pairwise events gives maximum likelihood parameters for the pairwise conditional sequence distribution. If the conditional events emphasize one item being better than the other based on the true labels, then the loss provides parameters that learn the ranking among the items. For the relaxed ordinal regression problem, we can express the logit sᵢₗ as log odds ratios between the probability that item i takes label of at most I and a label greater than l.

$${s}_{i ℓ} = log \frac{Pr ( {y}_{i} \leq ℓ \vert {x}_{i} )}{Pr ( {y}_{i} > ℓ \vert {x}_{i} )} = {θ}_{ℓ} - f ( {x}_{i} ) \hat{=} {θ}_{ℓ} - {z}_{i} \qquad ( 5 )$$

$$where {z}_{i} = f ( {x}_{i} ) .$$

For this form of relaxed ordinal regression, and for each l∈(0, 1, 2, . . . , L−1):

$${s}_{i ℓ} - {s}_{j ℓ} = log \frac{Pr ( {y}_{i} \leq ℓ \vert {x}_{i} ) \cdot Pr ( {y}_{j} > ℓ \vert {x}_{j} )}{Pr ( {y}_{i} > ℓ \vert {x}_{i} ) \cdot Pr ( {y}_{j} \leq ℓ \vert {x}_{j} )} = ( {θ}_{ℓ} - {z}_{i} ) - ( {θ}_{ℓ} - {z}_{j} ) = {z}_{j} - {z}_{i} . \qquad ( 6 )$$

The logit sᵢₗ−sⱼₗ, if converted to probability with the sigmoid function, gives the conditional probability that item i has label at most l and item j has label greater than l conditioned on the event that one of the items has label greater than I and the other a label at most l. The quantity sᵢₗ−sⱼₗ of equation (6) may be referred to as a combined score for the pair of items. This conditional probability is thus exactly a ranking conditional probability. Assuming a larger label is a better one, the difference zⱼ−zᵢ is thus exactly a logit that gives the probability that item j has a better label than item i under this model. The logits zⱼ and zᵢ are simply the output scores of the model for items i and j. For the relaxed ordinal regression model, the relations in equation (5) and equation (6) are true for every l. Thus, a pairwise ranking loss can simply minimize the negative logarithm of the conditional probability whose logit is zⱼ−zᵢ. Thus a loss component for the pair i, j is given by

$${L}_{ij}^{ℛ} ( {y}_{i} , {y}_{j} \vert {x}_{i} , {x}_{j} ) = I ( {y}_{i} > {y}_{j} ) log ( 1 + {e}^{- ( {z}_{i} - {z}_{j} )} ) + I ( {y}_{j} > {y}_{i} ) log ( 1 + {e}^{- ( {z}_{j} - {z}_{i} )} ) = I ( {y}_{i} \neq {y}_{j} ) log ( 1 + {e}^{- sign ( {y}_{i} - {y}_{j} ) ( {z}_{i} - {z}_{j} )} ) \qquad ( 7 )$$

where I(.) is again the indicator function, and sign(.) is the sign function. Thus, using the relaxed logistic ordinal regression model, a ranking loss, similar to a conditional pairwise ranking loss for binary logistic regression with respect to the output score of a model, can improve ranking among items that are shown together for the same query. Given the observation that increasing zᵢ=ƒ(xᵢ) gives higher likelihood of better (e.g., greater) labels, the sign of the differences between the example predictions also aligns with that of a binary pairwise ranking loss. If item i has a better label than item j, then the logit score applied to a ranking loss is zᵢ−zⱼ.

The loss in equation (7) can be applied when learning the relaxed ordinal regression model. However, unlike the pairwise ranking loss for binary logistic regression, it cannot be learned without the pointwise loss. (In binary logistic regression, a model can train only on the ranking loss, giving good ranking scores, but potentially very inaccurate individual engagement rate predictions.) Here, the loss in equation (4) may be applied as well, to at least learn the values of the thresholds θ. For ranking among objects those values cancel out, but they are needed for the ordinal scores. Tuning between the losses, however, can emphasize the ranking loss over the pointwise direct engagement loss. As discussed in later sections, fixed thresholds can sometimes be used. If that is the case, one can only apply ranking losses without individual engagement pointwise losses.

The loss in equation (7) is applied once regardless of the distance between the labels of the two items. An alternative approach is to enhance the loss as a function of the distance between the labels. If item i has label k, and item j has label m<k, then the conditional event that yⱼ≤l and yᵢ>l conditioned on one of the items being at most I and the other greater than l holds for l=m, m+1, . . . , k−1, i.e., for k−m labels. Therefore, the loss (which is equal for every l for which the event holds) can be applied k−m times. This gives a distance aware ranking loss of

$${L}_{ij}^{ℛ} ( {y}_{i} , {y}_{j} \vert {x}_{i} , {x}_{j} ) = \text{?} eLU ( {y}_{i} - {y}_{j} ) log ( 1 \text{?} ) + ReLu ( {y}_{j} - {y}_{i} ) \text{?} ( 1 + \text{?} ) = \vert {y}_{i} - {y}_{j} \vert log ( 1 + \text{?} ) \qquad ( 8 )$$

$$\text{?} \text{indicates text missing or illegible when filed}$$

where ReLU(x)=max(x, 0).

The derivation of the loss in equation (8) relies on independence of the logit ratios for consecutive labels in the interval between m and k. However, unlike some methods that learn each of the CDF points independently (with a different loss), such independence cannot be assumed for the relaxed ordinal regression, because the CDF points share the learned per example parameter zᵢ=ƒ(xᵢ) and also learn the thresholds θ not independently with the same loss. Applying equation (8) implies that an assumption that the probabilities making up the logits s_im, s_i; m+1, . . . , s_ik are independent for example i, and similarly for example j. Because these are not independent, the loss in equation (8) may overstate the ranking differences. A method to mitigate this is to use a tunable hyper-parameter, and revise equation (8) to

$${L}_{ij}^{ℛ} ( {y}_{i} , {y}_{j} \vert {x}_{i} , {x}_{j} ) = {\vert {y}_{i} - {y}_{j} \vert}^{α} log ( 1 + {e}^{- sign ( {y}_{i} - {y}_{j} ) ( {z}_{i} - {z}_{j} )} ) \qquad ( 9 )$$

where α:0<α<1 is an exponent that can tune down the label difference.

More principally, however, the loss can be defined differently. This yields alternative loss expressions. Using the conditional interpretation, the ranking event may be defined as the event that item i has a label not greater than m, while j has label greater than k−1, conditioned on the event that this relation holds either with i with respect to j or in the opposite direction. This gives

$${w}_{ij} ( {y}_{i} = m < {y}_{j} = k ) \hat{=} log \frac{Pr ( {y}_{i} \leq m \vert {x}_{i} ) \cdot Pr ( {y}_{j} > k - 1 \vert \text{?} )}{Pr ( \text{?} > k - 1 \vert {x}_{i} ) \cdot Pr ( {y}_{j} \leq m \vert {x}_{j} )} = log = \frac{( 1 + \text{?} ) ( 1 + \text{?} )}{( 1 + \text{?} ) ( 1 + \text{?} )} \qquad ( 10 )$$

$$\text{?} \text{indicates text missing or illegible when filed}$$

where the logit sᵢₗ and sⱼₗ are those defined in equation (5). The joint logit wᵢⱼ can now be used to define the pairwise loss for the pair i, j by

$${L}_{ij}^{ℛ} ( {y}_{i} , {y}_{j} \vert {x}_{i} , {x}_{j} ) = I ( {y}_{j} > {y}_{i} ) log ( 1 + \text{?} ) + I ( {y}_{j} < {y}_{i} ) log ( 1 + \text{?} ) \qquad ( 11 )$$

$$\text{?} \text{indicates text missing or illegible when filed}$$

where the separated the terms for the relational direction because we defined wᵢⱼ for y_i<y_j.

The loss in equation (11) is applied only on logits of the labels m and k−1. Through changing z; and z; affects predictions on all label values, and through changing the CDF values it also changes the predictions of labels m+1 and k (in addition). On the other hand, logit values of CDF points outside the {m, m+1, . . . , k−1} interval can also interact with the ranking loss. Specifically, the values of the label pair y_i=m and y_j=k convey signs of s_il and s_jl for these logits in equation (5) that are equal. For l<m, the true labels imply a positive ratio in equation (5) for both examples i and j, and if l>k−1, the true labels imply that for this pair the ratio in equation (5) has a negative sign. These relations imply a ranking loss that should also include the CDF points in which the logits labels are equal for both examples. Such a pairwise loss can be derived similarly to the listwise loss presented next. Following the description of the listwise loss, we describe the pairwise version.

### Ranking for Relaxed Ordinal Regression—Listwise Losses

The following approach can be applied for listwise losses. Let

$${v}_{i ℓ} \hat{=} \{ \begin{matrix}1 , & {y}_{i} \leq ℓ \\ - 1 , & {y}_{i} > ℓ\end{matrix} \qquad ( 12 )$$

be a sign function indicating the (inverse) sign of the true label yᵢ relative to l for every l∈{0, 1, 2, . . . , L−2}, i.e., if the true label of yᵢ is no greater than l, this sign is 1, and otherwise −1. Now, for each l an aggregate score may be defined as:

$${S}_{ℓ} \hat{=} {\sum }_{i = 1}^{N} {v}_{i ℓ} \cdot {s}_{i ℓ} = {\sum }_{i = 1}^{N} {v}_{i ℓ} \cdot ( {θ}_{ℓ} - {z}_{i} ) \qquad ( 13 )$$

where N is the number of items in the list. The score Sₗ equals some integer times the threshold θₗ superimposed with a linear combination of the model predictions zᵢ=ƒ(xᵢ) for all items in the list. This combination is different for each [symbol] The integer multiple of θₗ depends on the relations of the labels yᵢ of all N items to [symbol] and θₗ cancels out only if half the items have positive signs and half negative for some [symbol] . A listwise loss of

$${L}^{ℛ} ( {y}_{i} , … , {y}_{N} \vert {x}_{i} , … , {x}_{N} ) = {\sum }_{ℓ = 0}^{L - 2} log ( 1 + {e}^{- {S}_{ℓ}} ) \qquad ( 14 )$$

can be applied. The negative gradient on this loss pushes sᵢₗ down and zᵢ up for all examples for which yᵢ>l and in the opposite direction for examples for which yᵢ≤l for every l∈{0, 1, . . . , L−2}. This is the desired behavior of a ranking loss. Such a loss is desired to push the model towards predicting larger labels (pushing zᵢ up) for items which are observed to have larger labels and push the predictions of examples for which smaller labels are observed towards smaller labels (pushing zᵢi down). To enhance the loss as a ranking loss, label values may be omitted for which all examples have equal signs. This modifies the loss to

$${L}^{ℛ} ( {y}_{i} , … , {y}_{N} \vert {x}_{i} , … , {x}_{N} ) = {\sum }_{ℓ = 0}^{L - 2} I [ ∃ i > 1 : {v}_{i ℓ} \neq {v}_{1 ℓ} ] \cdot log ( 1 + \text{?} ) \qquad ( 15 )$$

$$\text{?} \text{indicates text missing or illegible when filed}$$

where I(.) is the indicator function, which is nonzero if at least one item has a different sign vᵢₗ from all others for label value [symbol] . Each of the thresholds θₗ only affected by the [symbol] -th component of the sum. However, the listwise loss components for all [symbol] -s may affect zᵢ of all examples. This is because of the parameter reduction by the relaxation of the loss.

The loss may be tightened, such that the loss is applied unless the multi-class label yᵢ are equal for all examples, giving

$${L}^{ℛ} ( {y}_{i} , … , {y}_{N} \vert {x}_{i} , … , {x}_{N} ) = I [ ∃ i > 1 : {y}_{i} \neq {y}_{1} ] \cdot {\sum }_{ℓ = 0}^{L - 2} log ( 1 + \text{?} ) . \qquad ( 16 )$$

$$\text{?} \text{indicates text missing or illegible when filed}$$

The listwise losses in equations (14)-(16) can also be applied as pairwise losses, as mentioned above, for a pair i,j, by revising equation (13) to compute aggregate logit scores sᵢⱼ; [symbol] per label [symbol] and the pair of examples i,j, instead of summing over all N examples in the set.

A listwise approach which is a combination of the listwise loss described and the pairwise loss defined in equations (10)-(11) can be applied by defining the loss in equation (14) to include only scores for labels [symbol] between the minimal label in the query set and the label smaller than the maximal one.

An extended Softmax listwise ranking loss may be defined. The score in equation (13) can be replaced by a sum of negative exponents of vᵢₗ(θₗ−zᵢ). Then, the variants of the losses in equations (14)-(16) can replace e^{-s}^{ₗ} by this new score to implement the extended Softmax listwise loss as a listwise loss for the relaxed ordinal regression.

Using the logit defined in equation (5) per item and per label value, other listwise losses can also be applied, such as the listwise Softmax loss, which uses a Softmax score between a positive and all other examples for all positive labels (in a binary setting). Another version of this loss aggregates the negative logarithm of Softmax scores between each of the positives and all negative examples, summing over all items with positive labels. (The difference is that a positive label is compared only the set of negatives in the list, excluding the other positives that are included with the standard Softmax listwise ranking loss). Both losses can be applied for each of the label values I, where for each label value l, a positive label is defined if y_i>l, and a negative label, otherwise. Then, Softmax scores are computed using logits that equal the negatives of the logits defined in equation (5).

### Distillation

Given the similarity of the ranking loss to that of binary logistic regression, ranking distillation may be applied on the model logit difference similarly to approaches for logistic regression. Distillation may be applied to leverage predictions of a complex expensive teacher model that may have been trained on much more data than a simple student model that has limitations because it has to be deployed, and must be trained fast, possibly on fewer examples. In the relaxed ordinal regression embodiments, both teacher and student models should train for ordinal regression with the relaxed model, for both pointwise and pairwise ranking. Distillation may require distilling both the threshold grid and the per-example scores. The threshold grid can be relayed to the student as a warm start grid of L−1 parameters. The student model can then use the same grid as the teacher model's, where updates of the grid can be applied from the teacher to the student during training, or the student can update the grid in its own training. In the latter case, however, this poses a risk that the student may diverge away from the teacher. When applying direct distillation of the scores zᵢ this may be a bigger concern. However, applying rank-distillation, the score differences zᵢ−zⱼ will be distilled from teacher to student. This can be done on all pairs, or only on pairs for which the true labels are different.

Distilling the score differences can be attained with L2 square loss between the teacher's score differences and the student's. Other losses, such as but not limited to L1, Huber, or quantile regression losses, can also be used, with proper tuning of parameters. Using the same ranking distillation techniques that were proposed for binary logistic regression is even simpler with fixed thresholds instead of learning a per dataset threshold. With predetermined fixed thresholds, zᵢ=ƒ(xᵢ). If both teacher and student use the same thresholds, distillation can distill zᵢ for pointwise loss and zᵢ−zⱼ for ranking loss without worrying about the thresholds. Fixed thresholds for direct pointwise and ranking losses with relaxed ordinal regression are discussed below.

### Solution Modality, Ranking Loss, and Illustrations

Relaxed ordinal regression learns a model outcome z_i=f(x_i) for example x_i and a set of thresholds marginalized over all examples to give label probabilities. The probability of each label is determined by integration over the logistic probability density function (PDF) (or a normal one, if a normal model is used) over the interval between θₗ₋₁−ƒ(xᵢ) and θₗ−ƒ(xᵢ). There exists a single k, for which 0∈[θₖ₋₁−ƒ(xᵢ), θₖ−ƒ(x)]. If there are no intervals wider than θₖ−θₖ₋₁, then the model will assign the largest probability to label k. However, if the widths of the intervals are not all equal, there may exist intervals wide enough which are shifted to other parts of the PDF, which can produce greater label probabilities. This can lead to multiple local maximal label probabilities, and multi-modality of the label distribution. Both the threshold interval widths and the per-example shifts can thus determine where the label with the maximal predicted probability hands up for a given example. Note that the intervals for the extreme labels (0 or L−1) are unbounded from either the left or the right by −∞ and ∞. Thus shifting the other side of these intervals towards 0 can increase the probability of the extreme label, and potentially produce local optima at those extremes, even if the true distribution gives small probabilities to these labels

Next, some label PMF prediction examples are demonstrated, first for direct relaxed ordinal regression, and then followed by illustrations of the effects of the ranking loss. For the illustrations we fix the thresholds and demonstrate how the threshold grid moves based on true label probabilities, giving different PMFs as function of the amount of movement.

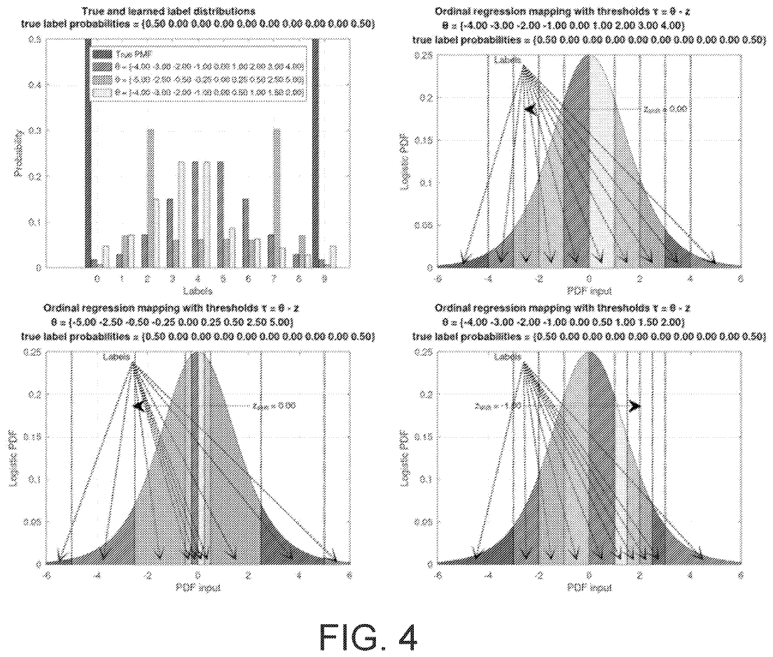

FIG. 4 shows various relaxed ordinal regression outcomes for a uniform distribution of the extreme labels (0 and L−1) where all other labels have 0 true probability. In FIG. 4, histogram and demonstrations of relaxed ordinal regression predictions with different threshold grids for a true label distribution which is uniform over the extreme labels (0 and L−1) are shown. The bar graph on the top left shows the true and predicted label PMFs. The remaining graphs show the relaxed ordinal PDF, the thresholds and areas that produce the PMFs of the different labels. Thresholds are shown on the figures with dotted vertical lines. The grid shift z=f(x) which minimizes the loss aggregated on all labels in (4) is also labeled on the graphs

More specifically, in FIG. 4, the top left image shows histograms of the true PMF and the learned PMFs which minimize the loss as in (4) averaged on the label distribution. Learned PMFs are shown for three different grids of thresholds, for which the partition of the PDF is shown in the other three images in the figure. The figure demonstrates that the thresholds can substantially change the predicted distribution, and the modality of the predictions. A uniform set of thresholds (top right) produces maximum at the mean label. This would also be a solution of logistic and linear regressions. However, it clearly does not fit the true label distribution here. A nonuniformly spaced grid of thresholds (bottom left) produces two peaks, but closer to the middle labels from where the true PMF peaks are. An asymmetric grid (bottom right) shifts the PMF such that probabilities are larger for labels where the grid has wider spacings.

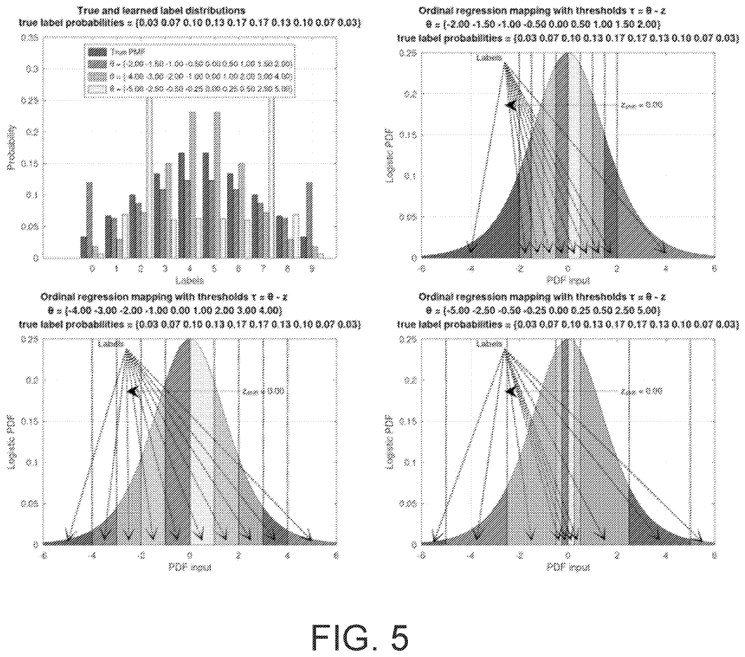

FIG. 5 shows similar graphs to those of FIG. 4 but for a different true label distribution, one that is symmetric around the middle labels and is peaked at those labels. In FIG. 5, histogram and demonstrations of relaxed ordinal regression predictions with different threshold grids for a symmetric label distribution which is peaked in the middle labels are shown. Graph details in FIG. 5 are identical to those of FIG. 4. More specifically, in FIG. 5, a uniform sufficiently spaced grid of thresholds (bottom left) is able to capture the shape of the distribution. However, a uniform grid of thresholds with smaller intervals (top right) is not able to capture the shape, and produces three peaks. One at the middle, but two at the extremes due to the larger extreme PDF intervals. A nonuniform threshold grid (bottom right) captures a bimodal distribution with two peaks matching the larger threshold intervals, independently of the true label distribution. We also note that the uniform grid captures the same distribution for both distributions of FIGS. 4 and 5 (top right in FIG. 4 and bottom left in FIG. 5). This illustrates a weakness of the problem relaxation, where certain threshold grids cannot distinguish between some distributions.

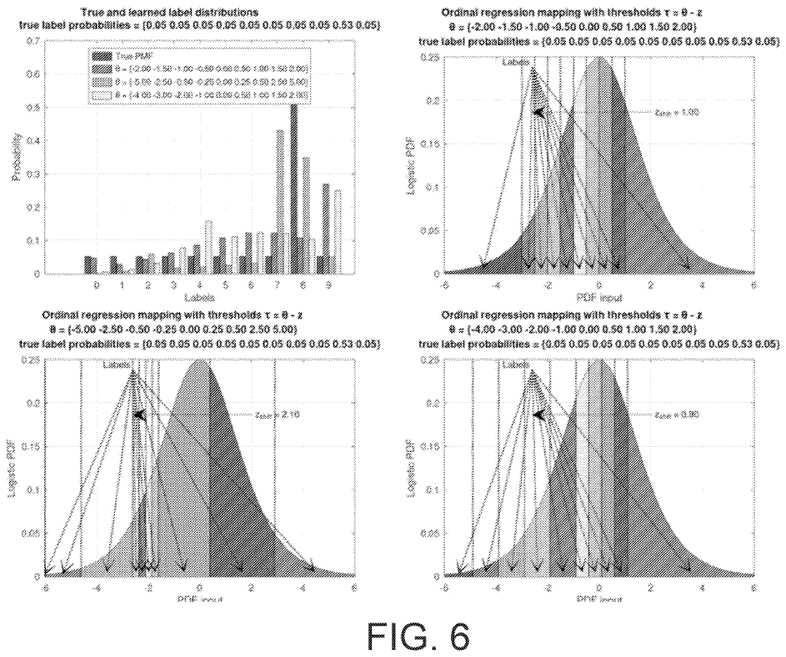

FIG. 6 shows similar graphs for a label distribution with a single dominant label close to but not at the extreme, where all other labels have uniform (low) probability. In FIG. 6, histogram and demonstrations of relaxed ordinal regression predictions with different threshold grids for a label distribution with one dominant label and uniform among all other labels are shown. Graph details of FIG. 6 are identical to those of FIG. 4. More specifically, in FIG. 6, the uniform (narrow) grid (top right) captures the maximum probability at the extreme label due to the large infinite interval, and smoothes the labels around the true peak due to its averaging effect. A nonuniform grid (bottom left) is able to shift a wide region to capture the peaked probability at the label next to the true peak. An asymmetric grid which is heavier on the opposite side to the large probability label (bottom right) captures a multimodal PMF, with a peak at the extreme, and then another one around the center, balancing the wider threshold intervals with the true large probability opposite to them.

### Ranking Loss Illustration

To demonstrate the effects of the additional ranking loss, we use similar images to the ones showing the behavior of relaxed ordinal regression on individual label distributions. Here, we take two different label distributions, and plot the PMFs resulting from the pointwise relaxed ordinal regression losses of equation (4). Then, we apply a convex combination of the pointwise loss of (4) with the ranking loss of equation (7), and again find the grid shifts that minimize the average combined loss on the two distributions (one shift for each distribution), and plot the resulting predicted PMFs for the two distributions.

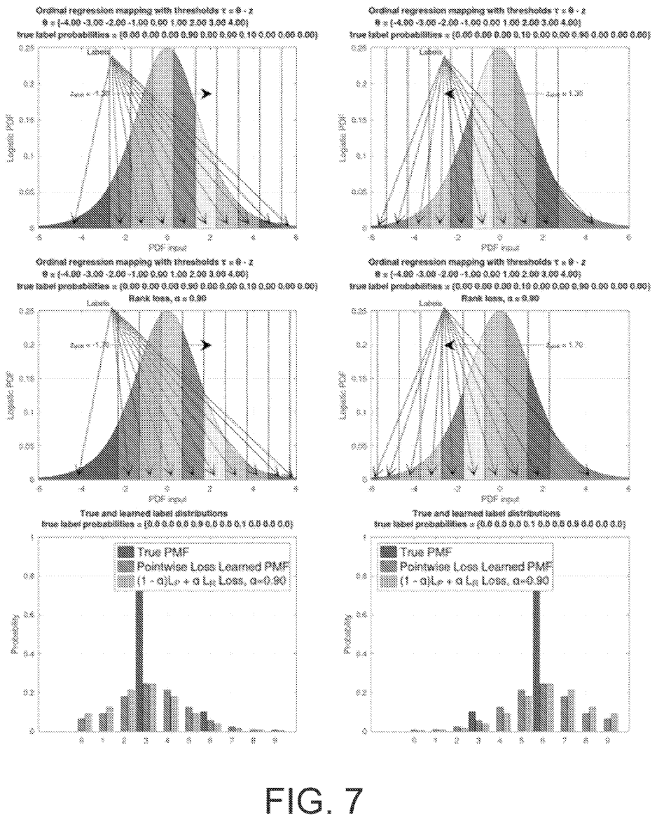

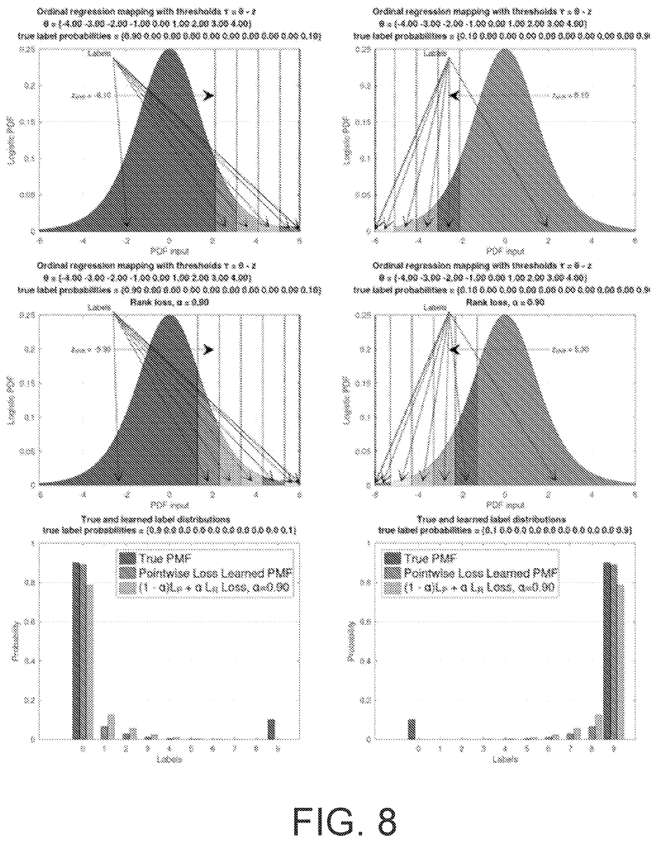

FIGS. 7-8 demonstrate two different cases. In both, two examples follow opposite distributions, with one label with high probability and another with low symmetrically around the middle labels. The high and low probability labels are exchanged between the two distributions. In FIG. 7, the nonzero probability labels are close to the middle, and in FIG. 8, they are the extreme labels, where all labels in between have 0 true probability. We use the same uniform grid of thresholds for the loss minimization for both cases.

In FIG. 7, relaxed ordinal regression for two skewed true label distributions skewed to labels close to the middle label are shown (one distribution on the left with its true and optimized histogram and the other on the right). At the top of FIG. 7 optimization without ranking loss is shown. At the middle-optimizing with pointwise loss with weight 1−α=0.1, and ranking with weight α=0.9. At the bottom of FIG. 7, bar graphs of the real PMF, and the learned PMFs with and without a ranking loss are shown. In FIG. 8, relaxed ordinal regression for two skewed true label distributions skewed to extreme labels are shown in a similar manner to FIG. 7. At the top of FIG. 8, optimization without ranking loss is shown. At the middle, optimizing with pointwise loss with weight 1−α=0.1, and ranking with weight α=0.9. At the bottom of FIG. 8, bar graphs of the real PMF, and the learned PMFs with and without a ranking loss are shown.

For the case in FIG. 7, where the skewed probability labels are closer to each other, we observe that adding the ranking loss tends to push the PMF to concentrate more on labels in the side of the label with the higher probability (where the bars which include the ranking loss are higher than the other ones which do not). This is also observed by the shifts of the threshold grid (labeled on the PDF graphs), which are in the same directions as the shifts without the ranking loss, but with larger magnitudes. Thus the ranking loss between the examples, in this case, strengthens the differences between them, by pushing apart the predictions of the two examples, one to predict lower label values, and the other to predict higher ones.

In FIG. 8, we observe a somewhat opposite behavior. Without the ranking loss the predictions are pushed farther apart, and the ranking loss enhances prediction probabilities of labels between the two observed labels, but still on the correct side. The shifts of the threshold grid with the ranking loss become more moderate than those without it. At first, one may think that this is an unexpected behavior. However, if we consider the distribution that the ranking loss in equation (7) optimizes, it turns out that this Bernoulli distribution of score differences is optimized at smaller score differences than those obtained for this case without the ranking loss. This is the reason that the ranking loss tends to pull the predicted labels closer, but not too close.

The somewhat opposite behaviors observed in FIG. 7-8 are typical of Sigmoid ranking losses, including losses as the binary pairwise RankNet and others. Ranking loss enhances ranking by pushing label predictions of two examples apart when the label prediction differences between the examples are small. When they are already large, the ranking loss may be optimized for smaller differences and it may no longer push the predictions more than the direct pointwise loss, and may instead pull the predictions closer. This is a desired behavior, as the need for the ranking loss is exactly when the differences of the pointwise loss are very subtle. When the pointwise loss already provides good ordering of examples, there is no need to apply a ranking loss.

### Fixed Thresholds and Solution Modality: In General

When the thresholds are learned, an example can have multiple labels that have local maximal probabilities in the model's predicted PMF. Instead of learning the grid of thresholds, this grid can be fixed. This constrains the solution even more, but allows determination of what solution and what solution modality is acceptable under some system constraints. Because this constrains the solution, the solution may be further suboptimal in summarizing predictions based on the real labels. However, in real applications, where subjective training labels are generated, it may be advantageous to fix the threshold values θ such that they constrain various types of solutions. A unimodal solution that guarantees a single label with maximal predicted probability for every example is one possibility. However, as discussed below, such a solution may not provide advantages that can be obtained by ordinal regression. Threshold grids that allow bi-modal solutions or solutions with multiple modes, on the other hand, that are set apart from each other, can take advantage of ordinal regression to provide better separation, for example, between favorable examples and disfavored ones. Using fixed thresholds can help in setting these solutions. Properly setting up such grids can lead to unimodal solutions in cases where there is a clear maximum, but multimodal solutions if no such clear maximum exists in the real data. Adding a ranking loss to these designs can further aid in separating families of examples between different relevance regions, perhaps giving larger probability to the mode that is more likely, and separating out the one that is less likely, instead of predicting the average of the modes (which will be the result if a unimodal solution is constrained or with linear or logistic regression). Examples of this separation are already observed in FIG. 7-8.

### Fixed Thresholds and Solution Modality: Unimodal Solutions

To approach a unimodal solution that guarantees that for every example a single label value will have the maximal prediction, all intervals of θ must be of equal width. Using the logistic link function (or a normal PDF) in this case, will maximize the label probability of the label for which the shifted PDF contains the point 0, where the link function is maximized. Constraining the widths of the intervals between all pairs of thresholds to an equal width, however, is impossible. This is because of the infinite support of the link function. The end intervals from both left and right sides thus have infinite widths. To address that, we can add two fake label values, one on each end, that will never occur in the true data. Because each of them will have a wide interval covered with the link function, the model will assign nonzero probabilities to these labels, but the probabilities predicted for all real labels can be normalized by the total probability of the real labels. This method can guarantee a unimodal solution for which a single (real) label value has maximum predicted probability. This method can be viewed as a form giving finite PDF support.

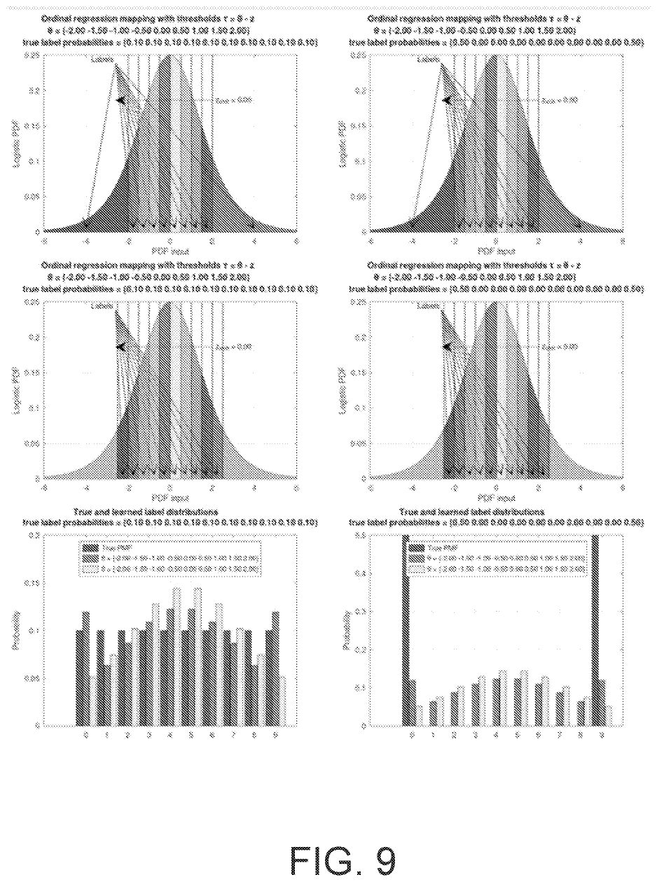

FIG. 9 demonstrates unimodal distributions obtained with the additional fake extreme labels for a uniform true label distribution (left) and a two extreme labels' uniform distribution (right). In both cases, the spacing of the threshold grid is not sufficiently wide, and without the fake labels, a distribution with three modes is obtained, one at the middle labels and two at the extreme labels due to the infinite support. The fake labels produce a unimodal solution in both cases, which is peaked at the middle.

In FIG. 9, relaxed ordinal regression with a uniformly spaced thresholds' grid with and without wrapping with fake labels for a uniform label distribution (left) and a uniform binary distribution on the two extreme labels (right) are shown. Ordinal regression PDF fitting curves are shown without adding extreme fake labels (top), and with adding them (middle). Gray filled areas are those covering the PDF regions for fake labels. Histograms with the true PMF, and the predicted ones without and with fake labels are shown at the bottom.

It is not clear, however, that there is benefit from doing relaxed ordinal regression constraining it to a unimodal solution. Such a solution will maximize the probability of the mean label, as already observed in FIGS. 4-5, and also in FIG. 9. Tuning the variance of the link function (by adding a temperature scalar to the logistic distribution, or a variance to the normal distribution) will enhance or suppress the predicted probability differences between the label with the maximal predicted probability and other labels. However, these effects can be reached by a much simpler approach with linear or logistic regression, where the predicted mean can be smeared by convolution with some normal or logistic (or other) distribution.

### Fixed Thresholds and Solution Modality: Bimodal and Multimodal Solutions

A fixed set of thresholds that allows for multi-modality, but perhaps limits the number of modes may still be beneficial over a unimodal constraint. It can allow for a wider range of solutions, still benefiting from the learned relations of ordinal regression. The simplest form is that of using an equal spacing grid of thresholds, but still allowing for the end labels to remain with an infinite range. Examples that are largely skewed in one of the two extreme directions may still be pushed to predict the extreme labels, while items for which training examples have concentrations around a certain label, will be pushed towards a unimodal solution of a label in the concentration. This gives, for example, a level of granularity which allows focusing on three levels of label concentration, the two extremes and some label value in the middle. Such a behavior may be desirable for (subjective) human labeled data, where the model's job is to extract some sensible behavior from subjective labels. (Note that with linear regression, the extreme examples could have very high prediction values, and outliers of concentrated examples may substantially skew the prediction of the concentration.)

Another alternative can allow for a limited number of higher width threshold intervals, which can occasionally allow for multimodal solutions, describing real effects in the data. A portion of the bars in FIG. 4 result from such a grid. This alternative skews the predicted PMF towards the labels for which the threshold intervals are wider. Thus it induces some prior skewing the distribution in favor of these labels. For example, we can give narrow regions to labels that are considered transitional and wider to more definite ones, roughly forcing the model to prefer the definite labels. Narrower intervals can fall in the main lobe, but if the wider intervals are wide enough they may still lead to larger probabilities even if the link function PDF has one of the narrower regions fall such that it contains the peak. If the peak falls on a label with the wider interval, then that label will take the maximal probability.

Fake labels can also be added to form buffering zones between labels. This can help separate or buffer between label groups, such as human labels, where it is natural to force the model to enhance differences between a favorable and a disfavored set of labels. The extra gap can increase gradients when training observes labels in the opposite label set to the current likely one, because the buffering interval leads to a likely smaller probability of the unlikely labels.

Ranking and Ranking Distillation with Fixed Thresholds

Using a fixed θ vector simplifies applying ranking loss, and ranking distillation. First, ranking loss can be applied without direct loss if only ranking matters, because there is no longer need to learn the parameters of θ. Thus equations (7) or (8) (or (14) or (15)) can be directly optimized over z_i=f(x_i) (and z_j=f(x_j)) for each example (or example pair). Second, ranking distillation is also easier, because keeping agreement on the values of the parameters of θ between the student and the teacher is no longer a concern. Instead, distillation can focus on distilling the scores z_i and/or their differences, which may be done similarly to distillation of binary label scores with binary logistic regression models.

### Temperature

In addition to learning z_i=f(x_i), the model can learn, for each of the training examples, a temperature scaling of the logistic link function. This can give more flexibility and fewer constraints on the solution, shifting the parameterization away from the set of thresholds. Thus one can use predetermined fixed thresholds, but still have fewer constraints on the range of solutions.

A small variance (or temperature) enhances the main mode, a large one enhances side modes. If the true distribution is closer to unimodal, training can learn a smaller temperature, enhancing the modality of the label distribution, and enhancing the labels around the label range with higher probability. (Note that the exact behavior depends also on the full true label distribution.) Larger variances lead to flatter link functions, which can more easily generate uniform, bimodal or multimodal predicted label distributions. Temperature flexibility thus gives a knob that can be used to suppress or enhance multimodal solutions, as shown in the examples below.

Adding a temperature parameter y, the label probability from equation (3) becomes,

$$Pr ( {y}_{i} = ℓ \vert {x}_{i} ) = \frac{1}{1 + \text{?}} - \frac{1}{1 + \text{?}} \qquad ( 17 )$$

$$\text{?} \text{indicates text missing or illegible when filed}$$

Then, the pointwise training loss of equation (4) is

$${L}_{i} = - {\sum }_{ℓ = 0}^{L - 1} I ( {y}_{i} = ℓ ) log [ \frac{1}{1 + \text{?}} - \frac{1}{1 + \text{?}} ] \qquad ( 18 )$$

$$\text{?} \text{indicates text missing or illegible when filed}$$

The loss can be scaled by the parameter y. However, using γ without an exponent smaller than 1 can create a threshold effect. The loss for ƒ(xᵢ):θₗ₋₁≤ƒ(xᵢ)≤θₗ will push γ towards 0, because the first term of the logarithmic function argument with γ→0 will tend to ∞ while the other to 0, but the loss will not tend to co because y→0 will be canceled by the loss scaling factor. This will push the distribution solution toward a unimodal one, enhancing one label (or two neighboring ones) and suppressing the rest. Such a loss will be very sensitive to fluctuations in the true label probabilities. Scaling (18) by γ^{v} for some v:0<v<1 can enhance a unimodal solution with less sensitivity. The hyperparameter v can enhance the behavior we demonstrate below for the loss in (18) (which we demonstrate with v=0).

In a similar manner to the pointwise loss, we can also introduce a ranking loss. A pairwise ranking loss which learns the temperature γᵢ for example i, in addition to z_i=f(x_i), is derived similarly to the derivation of equations (5) and (6) which gives equations (7)-(8), and is given by

$${L}_{ij}^{ℛ} ( {y}_{i} , {y}_{j} \vert {x}_{i} , {x}_{j} ) = I ( {y}_{i} \neq {y}_{j} ) \text{?} log \{ 1 + exp ( - sign ( {y}_{i} - {y}_{j} ) [ ( \frac{{z}_{i}}{{γ}_{i}} - \frac{{z}_{j}}{{γ}_{j}} ) - ( \frac{{θ}_{ℓ}}{{γ}_{i}} - \frac{{θ}_{ℓ}}{{γ}_{j}} ) ] ) \} \qquad ( 19 )$$

$$\text{?} \text{indicates text missing or illegible when filed}$$

Unlike equation (6), the thresholds θₗ may not cancel, unless the same temperature is learned for both examples. Other pairwise and listwise ranking losses described earlier can also be extended to the temperature setting.

A model can generate two scores for each example, zᵢ and γᵢ, and use a fixed threshold grid of L−1 values of θ. The temperature can aid in tuning the probabilities of different labels for an example, possibly tuning the probability of the label that falls in the main lobe. A lower temperature increases the probability of that label, and a larger one decreases it. This allows using a fixed grid with more flexibility. One benefit of such a fixed grid is that distillation can be easily applied by distilling the two learned parameters directly from the teacher to the student, without need to worry about the threshold parameters θ, but still giving better flexibility for the solution.

Similarly to the methods described earlier, fake labels can be used at the extremes to eliminate possible undesirable peaks for the extreme labels due to the infinite support of the link function. This becomes more important when a temperature γ>1 is learned. In such a case, the logistic PDF spans wider. With a fixed threshold, this gives wider regions to the extreme labels, potentially increasing their predicted probabilities relative to other labels. Adding fake labels at the extremes, eliminates this problem, still allowing large temperatures, which can give uniform or almost uniform predicted label distributions.

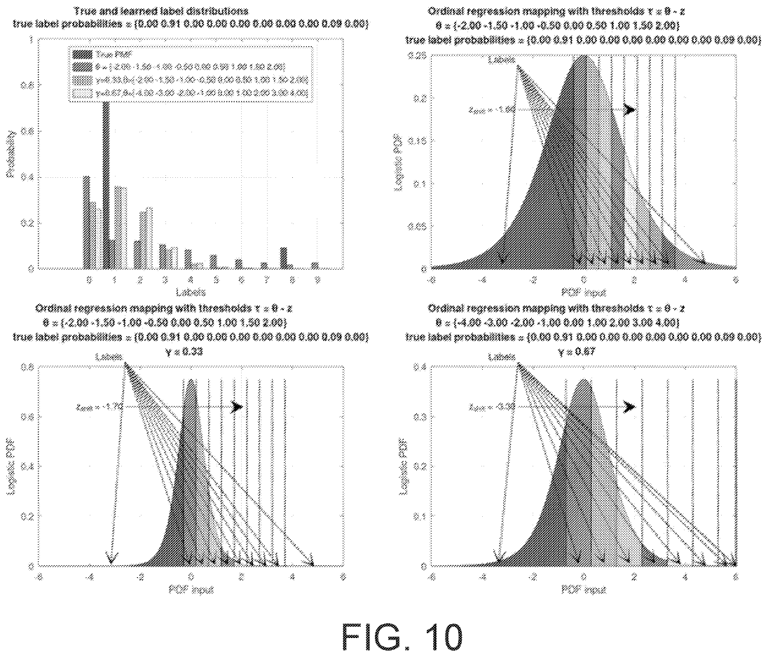

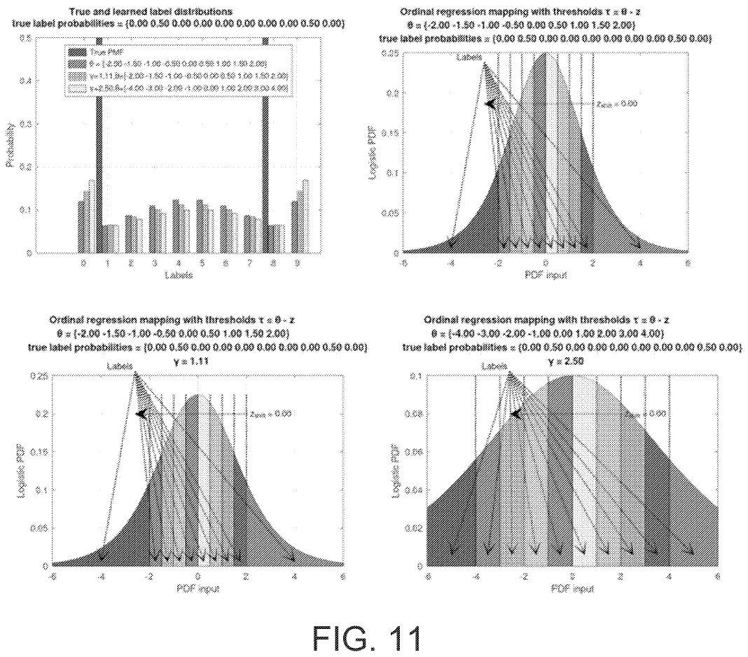

FIGS. 10-11 illustrate the effects of learning the temperature with the loss in equation (18) on two different true label distributions, which give positive probabilities to only two labels, one nonuniform (FIG. 10), and the other uniform (FIG. 11). In FIG. 10, histogram and demonstrations of relaxed ordinal regression predictions which optimize also the temperature of the link function per example with uniform threshold grids for a label distribution which is nonzero for only two labels, one with greater probability than the other are shown. The bar graph (top left) gives the true distribution, the predicted distribution for fixed temperature of 1 (red) whose link function relative to the grid is shown on the top right. Two uniform threshold grids with learned temperatures are shown on the bottom: Left: the same grid as that on the top right, but with learned temperature. Right: grid with double the spacing of the other one.

In the nonuniform case shown in FIG. 10, a low temperature is learned, smoothing out the prediction of the low probability label, and pushing the solution towards a unimodal one. This is a desired solution because, unlike linear or logistic regression, relaxed ordinal regression is able to select the region of the labels with larger probability instead of the mean label, even with a uniformly spaced set of thresholds, by learning the temperature parameter.

In FIG. 11, histogram and demonstrations of relaxed ordinal regression predictions which optimize also the temperature of the link function per example with uniform threshold grids for a label distribution which is nonzero for only two labels, both with equal probability (of 0.5) are shown. The graphs of FIG. 11 are similar to those shown in FIG. 10, but for the different true label distribution.

shown in FIG. 11 (e.g., the uniform case), if both labels are equiprobable, even with the temperature parameter, the relaxed ordinal regression learns a higher temperature parameter, which retains a multimodal solution, which in this case is necessary. Scaling the loss in (18) by γ^{v} with v:0<v<1, will enhance the case in FIG. 10 more, and smooth out the lower mode even more.

### Generalized Constrained Ordinal Regression

The constrained solution of ordinal regression, shown in equations (1)-(4) has been generalized in the literature to methods that use multiple parameters to model label distributions, which still use a link function such as the logistic or normal CDF to map regression parameters to probabilities. Similar ranking losses to those proposed through equations (5)-(19) (pairwise or listwise) can be imposed for these methods, following the same derivations described earlier, applied to the higher dimensional ordinal models.

### Further System Description

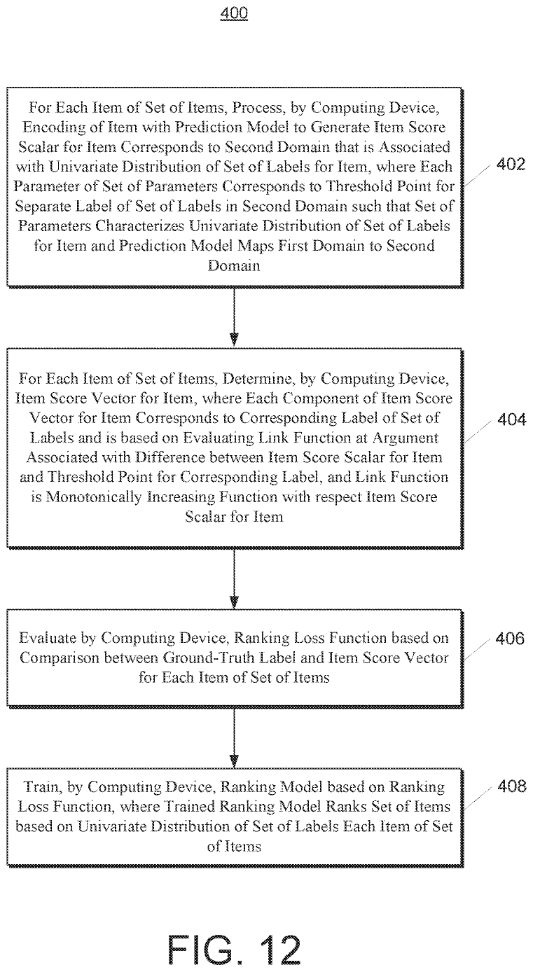

FIG. 12 depicts a flowchart diagram of an example method 400 for training a ranking model, according to example embodiments of the present disclosure. The ranking model may include a set of parameters (e.g., {θ₀≤θ₁≤ . . . θ_{L-2}}), a link function (e.g., σ(θᵢ−ƒ(xᵢ)),) and a prediction model (e.g., ƒ(xᵢ).) The prediction model may include a set of weights (e.g., encoded in the vector w). A set of training data may include (or encode) a set of items (or examples). For each item (or example) of the set of items (e.g., indexed by i∈{0 1, 2, 3, . . . , N}), the training data may include a ground-truth label, of a set of labels (e.g., yᵢ∈{0, 1, 2, 3, . . . , L−1}) that includes an ordering, for the item and an encoding of the item (e.g., the vector encoding or embedding x;) in a first domain (or a first multidimensional vector space shown in plot 200 of FIG. 1)

Method 400 begins at block 402, where, at a computing device and for each item of the set of items, the encoding of the item is processed with the prediction model to generate an item score scalar (e.g., zᵢ=ƒ(xᵢ) for the item. The item score scalar may corresponds to a second domain (e.g., real link interval 102 of FIG. 1) that is associated with a univariate distribution (e.g., a CDF such as but not limited to first CDF of 302 of FIG. 3) of the set of labels for the item. Each parameter (e.g., 01) of the set of threshold parameters corresponds to a threshold point for a separate label of the set of labels in the second domain (e.g., as shown in FIG. 3), The values of the set of parameters may characterize the univariate distribution of the set of labels for the item. The link function may map the first domain to the second domain (e.g., as shown in FIG. 1).

At block 404, at the computing device and for each item of the set of items, an item score vector for the item is determined. Each component of the item score vector (e.g., Su) for the item corresponds to a corresponding label of the set of labels and is based on evaluating the link function at an argument associated with a difference between the item score scalar for the item and the threshold point for the corresponding label (e.g., see equation (1)). The link function may be a monotonically increasing function with respect to the item score scalar for the item (e.g., see the mappings of FIG. 2).

At block 406, a ranking loss function may be evaluated at the computing device. Evaluating the ranking loss function may be based on a comparison between the ground-truth label and the item score vector for each item of the set of items. At block 408, and at the computing device, the ranking model may be trained based on the ranking loss function and may also use a pointwise per-label loss. The trained ranking model may rank the set of items based on the univariate distribution of the set of labels for each item of the set of items.

In various embodiments, the univariate distribution of the set of labels for the item includes a Cumulative Distribution Function (CDF). Each component of the item score vector for the item may indicate a probability for the item, in accordance with the univariate distribution of the set of labels for the item, and with respect to the corresponding label. In some embodiments, the ranking loss function may be based on a pairwise comparison of the set of items. In other embodiments, the ranking loss function may be based on a listwise comparison of the set of items.

In pairwise comparison embodiments, for each label of the set of labels, the ranking loss function may comprise a negative logarithm of a conditional probability that a first ground-truth label of a first item of the pairwise comparison is smaller than or equal to the label while a second-ground-truth label value of second input of the pairwise comparison is larger than the label, conditioned on an event that one of the first ground truth label value or the second ground truth label value is larger than the label and the other of the first ground truth label value or the second ground truth label value is smaller than the label.

In some embodiments (e.g., pairwise comparison embodiments), for each possible pair of items of the set of items, the computing device may generate a combined score vector for the possible pair of items (e.g., the vector quantity sᵢₗ−sⱼₗ of equation (6)). The possible pair of items includes a first item of the set of items and a second item of the set of items. That is, the combined score vector for the possible pair of items may comprise a difference between the item score for the first item and the item score for the second item.

In some embodiments, a distillation loss function may be evaluated by the computing device. The ranking model may be modified by the computing device based on the distillation loss function. In such embodiments, the distillation loss function may compare at least one of: the combined score and a teacher score generated for the first input and the second input by a teacher model, combined score differences between two scores or cumulative scores for lists of items and such combined scores by the teacher. sigmoid values generated from the combined score vector and the teacher score vector, and/or CDF values generated from the combined score vector and the teacher score vector.

The link function may comprise a logistic function. Training the ranking model may include updating the set of parameters and the set of weights of the link function based on the ranking loss function. The link function may further includes a temperature parameter. Training the ranking model may include learning a value for the temperature parameter.

The encoding of each item of the set of items may be a vector encoding. The set of weights of the prediction model may be represented by another vector encoding. The prediction model may include an inner product (e.g., a dot product) between the vector encoding of the item and the other vector encoding of the set of weights. The prediction model may be implemented by a neural network. The set of weights may characterize the neural network. The second domain may be a logit domain. A first item and a second item of the set of items may comprise responses to a shared query.

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1.-20. (canceled)

21. A computer-implemented method to perform learning of a ranking model that includes a set of parameters, a link function, and a prediction model including a set of weights, wherein a set of training data includes, for each item of a set of items, a ground-truth label, of a set of labels that includes an ordering, for the item and an encoding of the item in a first domain, the method comprising:
for each item of the set of items, processing, by a computing device, the encoding of the item with the prediction model to generate an item score scalar for the item that corresponds to a second domain that is associated with a univariate distribution of the set of labels for the item, wherein each parameter of the set of parameters corresponds to a threshold point for a separate label of the set of labels in the second domain such that the set of parameters with the item's score characterizes the univariate distribution of the set of labels for the item and the prediction model maps the first domain to the second domain;
for each item of the set of items, determining, by the computing device, an item score for the item, wherein the item with the set of threshold parameters give a score vector, wherein each component of the item score vector for the item corresponds to a corresponding label of the set of labels and is based on evaluating the link function at an argument associated with a difference between the item score scalar for the item and the threshold point for the corresponding label, and the link function is a monotonically increasing function with respect to the item score scalar for the item;
evaluating, by the computing device, a ranking loss function based on a comparison between the ground-truth label of the item and other items and the item score vector for each item of the set of items; and
training, by the computing function, the ranking model based on the ranking loss function, wherein the trained ranking model ranks the set of items based on their score vectors and the link function of the set of labels for each item of the set of items.

22. The computer-implemented method of claim 1, wherein the link function is a univariate distribution and is used to obtain a Cumulative Distribution Function (CDF).

23. The computer-implemented method of claim 21, wherein each component of the item score vector for the item indicates a probability for the item, in accordance with the univariate distribution of the set of labels for the item, with respect to the corresponding label.

24. The computer-implemented method of claim 21, wherein the ranking loss function is based on a pairwise comparison of the set of items.

25. The computer-implemented method claim 24, wherein, for each label of the set of labels, the ranking loss function comprises a negative logarithm of a conditional probability that a first ground-truth label of a first item of the pairwise comparison is smaller than or equal to a label while a second-ground-truth label value of second input of the pairwise comparison is larger than the label, conditioned on an event that one of the first ground truth label value or the second ground truth label value is larger than the label and the other of the first ground truth label value or the second ground truth label value is smaller than the label.

26. The computer implemented method of any of claim 21, further comprising of adding the losses computed for each possible label value.

27. The computer implemented method of any of claim 21, further comprising of scaling the magnitude of the additive loss.

28. The computer implemented method of claim 21, comprising of applying a training loss which equals to the negative logarithm of the probability that one item has a ground truth label greater than some label value, and the other item has a ground truth label smaller than a smaller label value than the one compared to first item, wherein the probability is computed by the items' score vectors and the link function.

29. The computer implemented method of claim 21, wherein a loss is applied on a list of items, using the score vectors computed for the list of items and the link function.

30. The computer-implemented method of claim 21, further comprising:
evaluating, by the computing system, a distillation loss function, wherein the distillation loss function compares:
the combined score vector and a teacher score vector generated for the first input and the second input by a teacher model;
combined score difference vectors between two scores or cumulative scores for lists of items and such combined scores by the teacher;
sigmoid values generated from the combined score vector and the teacher score vector; or
CDF values generated from the combined score vector and the teacher score vector; and
modifying, by the computing device, the machine-learned ranking model based on the distillation loss function.

31. The computer-implemented method of claim 21, wherein the link function comprises a logistic function.

32. The computer-implemented method of claim 21, wherein training the ranking model includes updating the set of threshold parameters and the set of weights of the prediction model based on the ranking loss function for sets of items

33. The computer-implemented method of claim 21, wherein the link function further includes a temperature parameter and training the ranking model includes learning a value for the temperature parameter.

34. The computer-implemented method of claim 21, wherein a first item and a second item or items of the set of items may comprise responses to a shared query.

35. The computer-implemented method of claim 21, wherein the threshold parameters allocate probabilities to fake labels that are not included in the possible label outcome set.

36. The computer-implemented method of claim 21, wherein the thresholds are set at fixed label, and training learns only the prediction model parameters.

37. The computer-implemented method of claim 21, wherein the encoding of each item of the set of items is a vector encoding, the set of weights of the prediction model is represented by another vector encoding, and the prediction model includes an inner product between the vector encoding of the item and the other vector encoding of the set of weight.

38. The computer-implemented method of claim 21, wherein the second domain is a logit domain.

39. A computing system, comprising:
one or more processors; and
one or more non-transitory computer-readable media that, when executed by the one or more processors, cause the computer system to perform operations of a method to perform learning of a ranking model that includes a set of parameters, a link function, and a prediction model including a set of weights, wherein a set of training data includes, for each item of a set of items, a ground-truth label, of a set of labels that includes an ordering, for the item and an encoding of the item in a first domain, the operations comprising:
for each item of the set of items, processing, by a computing device, the encoding of the item with the prediction model to generate an item score scalar for the item that corresponds to a second domain that is associated with a univariate distribution of the set of labels for the item, wherein each parameter of the set of parameters corresponds to a threshold point for a separate label of the set of labels in the second domain such that the set of parameters with the item's score characterizes the univariate distribution of the set of labels for the item and the prediction model maps the first domain to the second domain;
for each item of the set of items, determining, by the computing device, an item score for the item, wherein the item with the set of threshold parameters give a score vector, wherein each component of the item score vector for the item corresponds to a corresponding label of the set of labels and is based on evaluating the link function at an argument associated with a difference between the item score scalar for the item and the threshold point for the corresponding label, and the link function is a monotonically increasing function with respect to the item score scalar for the item;
evaluating, by the computing device, a ranking loss function based on a comparison between the ground-truth label of the item and other items and the item score vector for each item of the set of items; and
training, by the computing function, the ranking model based on the ranking loss function, wherein the trained ranking model ranks the set of items based on their score vectors and the link function of the set of labels for each item of the set of items.

40. The computing system of claim 39, wherein the link function is a univariate distribution and is used to obtain a Cumulative Distribution Function (CDF).
